(19) United States
(12) Patent Application Publication
(10) Pub. No.: US 2013/0151201 A1
(43) Pub. Date: Jun. 13, 2013

(54) METHOD AND SYSTEM FOR PROCESSING RECEIVED DATA

(71) Applicant: John W. McCorkle, Vienna, VA (US)

(72) Inventor: John W. McCorkle, Vienna, VA (US)

(21) Appl. No.: 13/708,832

(22) Filed: Dec. 7, 2012

Related U.S. Application Data
(60) Provisional application No. 61/568,550, filed on Dec. 8, 2011.

(51) Int. Cl. G06F 17/14

(52) U.S. Cl. 702/189

(57) ABSTRACT

A method to produce low sidelobe and high resolution spectral analysis on short data records allowing higher resolution and more dynamic range on systems including radar (SAR, GMTI, MTI), sonar, electro-cardiograms, sonograms, MRI, CAT scan, seismic, and allowing real-time analysis on dynamic systems that must operate on short data records such as engine or machine controls and failure analysis.

The present invention claims priority from U.S. provisional patent application No. 61/568,550, filed on 8 Dec. 2011, titled METHOD AND SYSTEM FOR PROCESSING RECEIVED DATA, the contents of which are hereby incorporated by reference in their entirety.

### FIELD OF THE INVENTION

The present invention relates generally to methods of converting data collected in one domain, such as time domain or frequency domain, and converting it into the other domain, with low errors or low sidelobes. The present invention relates to seismic, acoustic, RF, and optical sensors including magnetic resonance imaging (MRI), sonograms, echocardiograms, sonar, sonic sounders, array beam-forming, radars, including pulse compression radars such as those that use chirp or stepped frequency waveforms, or multi-input multi-output (MIMO) waveform based, synthetic aperture radar (SAR), moving target indication (MTI) radar, and ground moving target indication (GMTI) radar.

### BACKGROUND OF THE INVENTION

A Fourier transform is a mathematical method of converting an infinitely long, or repetitive, time domain signal into a frequency domain spectrum—a sum of a set of sine waves. A discrete Fourier transform (DFT) is a mathematical method of estimating the frequency domain power spectrum of an infinitely long signal, based on a finite length piece of the signal, represented by a finite number of samples of the signal waveform. A discrete inverse Fourier transform (IDFT) is a method of estimating a time-domain waveform, from a finite set of frequency domain samples covering a finite bandwidth. In either case, i.e. DFT or IDFT, artifacts or errors are made in the process due to the finite nature of the data. In the case of the DFT, sidelobes appear that are caused largely by the abrupt ends of the finite data set. In the case of the IDFT, the time-domain waveform exhibits blurring as well as erroneous peaks and ringing.

Due to the broad applicability of the DFT and IDFT in all sorts of products, from analyzing RF and acoustic signals to analyzing data from arbitrary processes like the prices of stock, there has been great interest in finding ways to mitigate or reduce these errors or artifacts. As a result, there are many methods of estimating the power spectrum of a signal. The book “High-Resolution and Robust Signal Processing” edited by Yingbo Hua, Alex Gershman, and Qi Cheng, ISBN: 0-8247-4752-6, Marcel Dekker, Inc. 2004 gives details on many different techniques, including both model based (or parametric) methods and non-model based (or non parametric) methods. Model based methods, such a MUSIC (Multiple Signal Classification), assume that the measured signal was produced by a small countable number of sinusoids, or a small number of countable damped sinusoids. There are three major problems with these methods. First, they do not operate well in noise. Typically, measured signals contain broadband noise that does not match this sum-of-N-sines model, where N is an integer that is small. Secondly, these methods work poorly when the assumed number of tones does not match the actual number of tones in the data. Thirdly, often the model (a small number of countable sinusoids) does not match the problem. For example, if a radar is looking at a forest, where because of the way the radar is built, each tree, stump, truck, person, etc. represents a sinusoid, the model breaks down because N is large and not practically countable. Non-model-based techniques, including the methods described in, “Spatially Variant Apodization for Image Reconstruction from Partial Fourier Data” IEEE Trans on Image Processing, Vol. 9, No. 11, November 2000 pp 1914-1925 improve resolution and suppress artifact sidelobes. But they also erroneously suppress closely-spaced frequencies. Furthermore, the constraints used in the above non-parametric techniques constrain the suppression of artifact sidelobes. The currently-disclosed technique is less constrained in that it allows a comprehensive set of normalized window tapers (e.g. Raised sine, Triangle, Hann, Hamming, Kaiser, Nutall, Chebychev, Taylor, Random/arbitrary, etc.) to bear on the artifact sidelobes. It is also less constrained in that it discloses a mechanism to reduce or eliminate the erroneous suppression of closely spaced frequencies.

The classic way of reducing sidelobes is to taper the data set so that the data amplitudes are dropping toward zero at the ends of the finite data. This method, however, has the serious drawback of blurring the output, or reducing the resolution. The various classic window taper types, like Rectangular (highest resolution), Hann, Hamming, Blackman, Nutall, Kaiser, Chebyshev (lowest sidelobes but poorest resolution), represent different tradeoffs between resolution and close-in or farther out sidelobe levels.

As recognized by the present inventor, none of the above window tapers, however, provide high resolution and low sidelobes simultaneously. Therefore, it would be advantageous for the method of operating on finite, noisy data to simultaneously allow both high resolution, and low sidelobe artifacts.

### SUMMARY OF THE INVENTION

In view of the foregoing, there exists a need in the art, and accordingly, it is an object of this invention to provide a method to convert time domain data to frequency domain data, or to take data in either domain, and sharpen it so that it has, simultaneously both higher resolution and lower sidelobes. It is also an object of this invention to provide, with a shorter data set, results that are as accurate as previous approaches that required a longer data set.

For example, it is an object of this invention to provide a novel apparatus and system for providing high-resolution low-sidelobe range-Doppler maps of moving objects, where the range resolution is higher than usually provided by bandwidth of the radar or sonar, and where the Doppler resolution is higher than is usually provided by the observation time.

As another example, it is an object of this invention to provide high resolution radar imagery of objects buried underground, where the bandwidth is severely restricted by the RF attenuation in the ground.

As further examples, it is an object of this invention to provide high resolution sonogram imagery, computer aided tomography (CAT) scan imagery, magnetic resonance imagery (MRI), sonar imagery, and more accurate analysis of arbitrary data sets, such as stock prices, or communications waveforms, or astronomy data, or shorter pieces of data on a factory floor that would allow quicker fault analysis.

These and other objects of the invention are accomplished by using a family of scaled window tapers and for each output point, choosing the scaled window taper whose output is the minimum across all scaled window tapers, and inverse scaling that minimum according to the chosen scaled window taper to generate each final output point. The resolution and sidelobe levels of the output data is data dependent and can be as sharp as a rectangular window, yet have sidelobes as low as an extremely low sidelobe Chebyshev window.

With these and other objects, advantages and features of the invention that may become hereinafter apparent, the nature of the invention may be more clearly understood by reference to the following detailed description of the invention, the appended claims and to the several drawings herein.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a block diagram of a basic active system including a transmitter and a receiver, such as a radar or sonar system, according to disclosed embodiments;

FIG. 2 is a block diagram showing the basic operation of the data processor of FIG. 1 in producing the output data based on a variety of possible input signals, according to disclosed embodiments;

FIG. 3 is a block diagram of the data processor of FIG. 1, according to disclosed embodiments;

FIG. 4 is a block diagram of the data processor of FIG. 1, according to alternate disclosed embodiments;

FIG. 5 is a flow chart showing the disclosed method for operation on one-dimensional data, according to disclosed embodiments;

FIG. 6 is a flow chart showing the disclosed method for operation on two-dimensional data, according to disclosed embodiments;

FIG. 7 is a graph showing a low-pass filter function based on the disclosed methods, in which both the final output, and the intermediate functions provided by the different tapered windows are shown, according to a disclosed embodiment;

FIG. 8 is an expanded view of FIG. 7, showing in greater detail how multiple different window taper functions create a notch at a different frequency, according to disclosed embodiments;

FIG. 9 is a graph showing the suppression of signal strength in classic windowing methods;

FIG. 10 is a graph comparing several alternate window taper functions to the output of the circuit of FIG. 1 using the method of FIG. 5; and

FIG. 11 is an expanded view of a portion of FIG. 10 showing the significantly higher resolution, and the lack of suppression on close tones achieved according to disclosed embodiments.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, may be supported with or in integrated circuits (ICs), such as dynamic random access memory (DRAM) devices, static random access memory (SRAM) devices, or the like. In particular, they may be implemented using transistors such as CMOS, NMOS, BJT, FET, HEMT, pHEMT etc. implemented in a variety of materials such as silicon, silicon germanium, GaAs, InP, GaN, etc. It is expected that one of ordinary skill, notwithstanding possibly significant effort and many design choices motivated by, for example, available time, current technology, and economic considerations, when guided by the concepts and principles disclosed herein will be readily capable of generating such ICs with minimal experimentation. Therefore, in the interest of brevity and minimization of any risk of obscuring the principles and concepts according to the present invention, further discussion of such ICs will be limited to the essentials with respect to the principles and concepts used by the exemplary embodiments.

Basic System

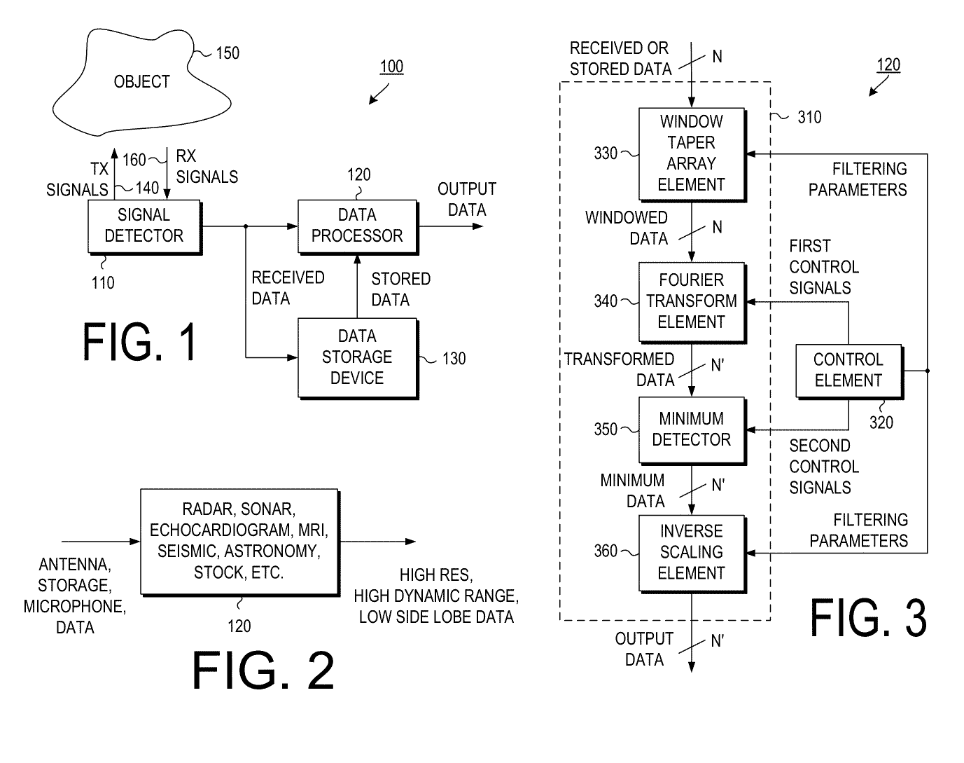

FIG. 1 is a drawing of a basic active system, in other words, a system that has a transmitter and a receiver, such as a radar or sonar system, and can implement the disclosed processing method. As shown in FIG. 1, the system 100 includes a signal detector 110, a data processor 120, and a data storage device 130.

The signal detector 110 emits transmitted signals 140, which are reflected off of an object 150, and are returned to the signal detector 110 as received signals 160. In various embodiments the signal detector 110 could be a radar system (e.g., pulse compression, step frequency, SAR, MTI, GMTI, etc.), a sonar system, a sonogram system, a sonic sounding system, an echocardiogram system, an MRI system, a MIMO system, or the like. In alternate embodiments, the signal detector 110 could omit the transmitting of signals 140, and simply receive signals 160. For example, in such embodiments the signal detector 110 could be a seismic detector, a telescope, or the like, which receive signals from a distant object 150 or objects.

In operation, the signal detector 110 receives the received signals 160 and extracts received data from these received signals 160. This received data can either be sent to the data processor 120 for immediate processing, to the data storage device 130 for later processing, or to both the data processor 120 and the data storage device 130.

The data processor 120 receives either received data from the signal detector 110 or stored data from the data storage device 130, and processes the received/stored data to generate output data. This output data provides extracted information regarding the object 150. Part of the processing the data processor 120 can perform is reducing sidelobes in the receipt/stored data. One way to accomplish this is through the use of a window taper function.

In particular, the data processor 120 may apply the method disclosed below to received/stored data, such that accurate, high resolution output data is generated with low error artifacts such as processing-induced sidelobes.

The data storage device 130 obtains the received data received from the signal detector 110 and stores it for a period of time. The data storage device 130 may provide this received data to the data processor 120 as stored data at a future date or time.

FIG. 2 is a block diagram showing the basic operation of the data processor 120 of FIG. 1 in producing the output data based on a variety of possible input signals, according to disclosed embodiments. As shown in FIG. 2, the data processor 120 can be provided with data from a variety of sources, such as an antenna, a storage device, a microphone, a sonic receiver, etc. This input represents the variety of received data or stored data that can be provided to the data processor 120. In turn, the processor produces high-resolution, high-dynamic-range data that contains very low sidelobes.

FIG. 3 is a block diagram of the data processor of FIG. 1, according to disclosed embodiments. As shown in FIG. 3, the data processor 120, the data processor includes a signal processor 310 and a control element 320. The control element 310 further includes a window taper array element 330, a Fourier transform array 340, a minimum detector 350, and an inverse scaling element 360.

The control element 320 provides filtering parameters to control operation of the window taper array 330 and the inverse scaling element 360. It also provides a first control signals to control operation of the Fourier transform element 340, and second control signals to control operation of the minimum detector 350.

The window taper array element 230 is provided with either received data (e.g., an N×1 data record vector of initial data elements) from a signal detector 110 or stored data from a data storage device 130. The window taper array 230 then applies two or more scaled window taper functions (e.g., P window taper functions) to the received/stored data to generate a windowed data array (e.g., an N×P windowed data array of windowed data elements). For the sake of clarity, it can be considered that each column of the windowed data array would be the input data windowed by a particular one of the P scaled window taper functions.

The Fourier transform element 340 receives the windowed data (i.e., the N×P windowed data array) from the window taper array element 330, and transforms the filtered data using a Fourier transform to generate transformed data (e.g., an N′×P transformed data array of transformed data elements).

The minimum detector 350 receives the transformed data from the Fourier transform element 340, and determines the minimum point across all of the windows in the transformed data (e.g. across any row in the N′×P transformed data array). In particular, that the minimum detector 350 selects both the minimum data point for each set of associated data points (i.e., each row in the N′×P transformed data array), and the scaled window taper function associated with that minimum data point. In doing so, the minimum detector 350 generates minimum data (e.g., an N′×1 intermediate output vector of intermediate data elements).

If, during the choosing of the minimum data points, an identical minimum value occurs multiple times in a single row of the transformed data, a selected minimum value a selected window taper function is determined based on the scaling factors associated with all of the pieces of data that share that minimum value. The selected minimum value is the one associated with the window taper function that has the smallest scale factor, among the window taper functions associated with the identical minimum;

The inverse scaling element 360 receives the minimum data from the minimum detector 350, and applies inverse scaling to each minimum data point. This inverse scaling is based on the scaled window taper function associated with a given minimum data point, and can be determined from the scaled window taper function information in the minimum data and the filtering parameters received from the control element 320.

In operation, the inverse scaling is performed on the minimum point selected from each row of the transformed data (e.g., the N′×1 intermediate data array). This results in a series of inverse-scaled minimum points, which can be represented by a single column of data that forms the output data (an N′×1 output data array). Because of the particular arrangement of processing, this output data simultaneously has both high resolution and low sidelobes.

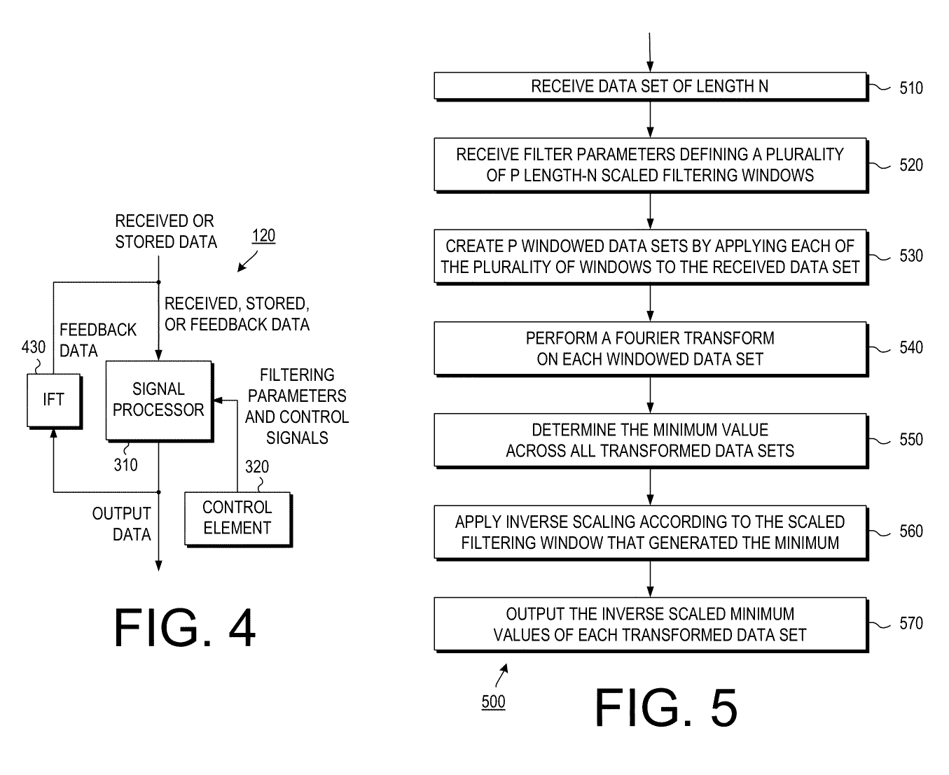

FIG. 4 is a block diagram of the data processor 120 of FIG. 1, according to alternate disclosed embodiments. As shown in FIG. 4, the data processor 120 includes a signal processor 310, a control element 320, and an inverse Fourier transform (IFT) element 430.

The signal processor 310 and the control element 320 operate as described above with respect FIG. 3.

The IFT element 430 receives the output data from the signal processor 310 and performs an inverse Fourier transform corresponding to the Fourier transform performed by the Fourier transform element 340 in the signal processor 310. This process returns the output data to the sampling rate used by the input of the window taper array element 330 in the signal processor 310. For example, the signal processor 310 may receive input data at a sampling rate of N, and the Fourier transform element may transform that data to a sampling rate of N′, which is the sampling rate that the output data is provided at. The IFT element 430 converts the output data back to a sampling rate of N, so that it can be fed back as new input data for the signal processor 310. In this way, the processing can be repeated two or more times on the same received data.

The filtering parameters provided by the control element 320 are best explained by way of illustration. In particular, the filtering parameters may be thought of as a filtering table containing a list pointing to all of the scaled window tapers that are used by the window taper array element 330. In the filtering table, each column represents a particular scaled window taper, and each row represent the parameters that define the scaled window tapers. In some embodiments, one row could indicate the window type, such as a raised triangle, a raised sine, a raised sum of two cosines, a raised sum of three cosines [i.e. S(a₀+a₁·cos(x)+a₂·cos(2x)+a₃·cos(3x))], Gaussian, Taylor, Kaiser, Chebyshev etc. Another row could indicate the scaling factor used by that window type. (The factor S in the equation for a raised sum of three cosines window type represents the scaling factor for that window type). Other rows can indicate the parameter values used for the particular window type. For example, a window that is a raised sum of three cosines has four parameters (a0, a1, a2, a3) as seen from the equation above.

By way of example, these exemplary entries will be described with reference to the raised sum of three cosines window type. The raised sum of three cosines window type can be represented by the following equation:

S(a₀+a₁·cos(x)+a₂·cos(2x)+a₃·cos(3x)) (1)

For this window taper, the window type is “raised sum of three cosines,” the scaling factor is S, and the parameter values are a₀, a₁, a₂, and a₃. This information could be contained in three respective rows of the column representing the raised sum of three cosines window taper.

The number columns in the filter table would be the same as the number of columns in the window taper array used by the window taper array element 330.

In some embodiment, all window taper functions are normalized such that the values in each window taper function sum to a common value (e.g., the values in each taper sum could equal A/αₖ, where A is an arbitrary real number and αₖ is a scaling factor for a k^{th} window taper function). Typically, A is either 1 or N, where N is the number of elements in the input record (which is the same as the number of elements in the window taper array). In the case in which window taper functions are normalized such that the values in each window taper function sum to 1, a rectangular window would have values of 1/N. In the case in which window tapir functions are normalized such that the values in each taper sum to N, a rectangular window would have all values of 1.

The amount and degree of scaling will vary by application; there is no universally best scaling. Rather, the scaling is made according to the benefits it provides to any particular application. Typically, a good scaling operation involves multiplying each window by a scaling factor such that two tones in a received signal that are 1 DFT bin apart, come out at a level that is the same as what an unscaled window would produce with a single tone by itself. Since window tapers that heavily suppress sidelobes, also suppress close tones, scaling allows mitigation of this unwanted suppression.

Method of Operation

FIG. 5 is a flow chart showing the disclosed method 500 for operation on one-dimensional data, according to disclosed embodiments. As shown in FIG. 5, the method 500 begins by receiving a data set of length N (510).

The method then receives filter parameters defining a plurality of P length-N scaled filtering windows (520).

The method then creates P windowed data sets by applying each of the plurality of windows to the received data set (530). The P windowed data sets may be arranged as a windowed array in which each windowed data set forms a column in the windowed array. The N rows of the array will each contain P windowed data points, with each row representing one of the original data points from the received data set.

The method then performs a Fourier transform on each windowed data set (540). In performing this operation, the method can generate a P×N′ transformed array, where the relationship between N and N′ depends upon how the Fourier transform is implemented.

The method then determines the minimum value across each of the transformed data sets (550). This can be accomplished by determining the minimum value in each of the N′ rows of a P×N' transformed array. In performing this operation, the method can generate a minimum data set of length N′.

The method then applies inverse scaling according to the scaled filtering window that generated the selected minimum value (560). In performing this operation, the method can generate an inverse-scaled data set of length N′.

Finally, the inverse scaled minimum values of each transformed data set are outputted as output data (570). In other words, the method can output the inverse-scaled data set of length N′ as the output data set of length N′.

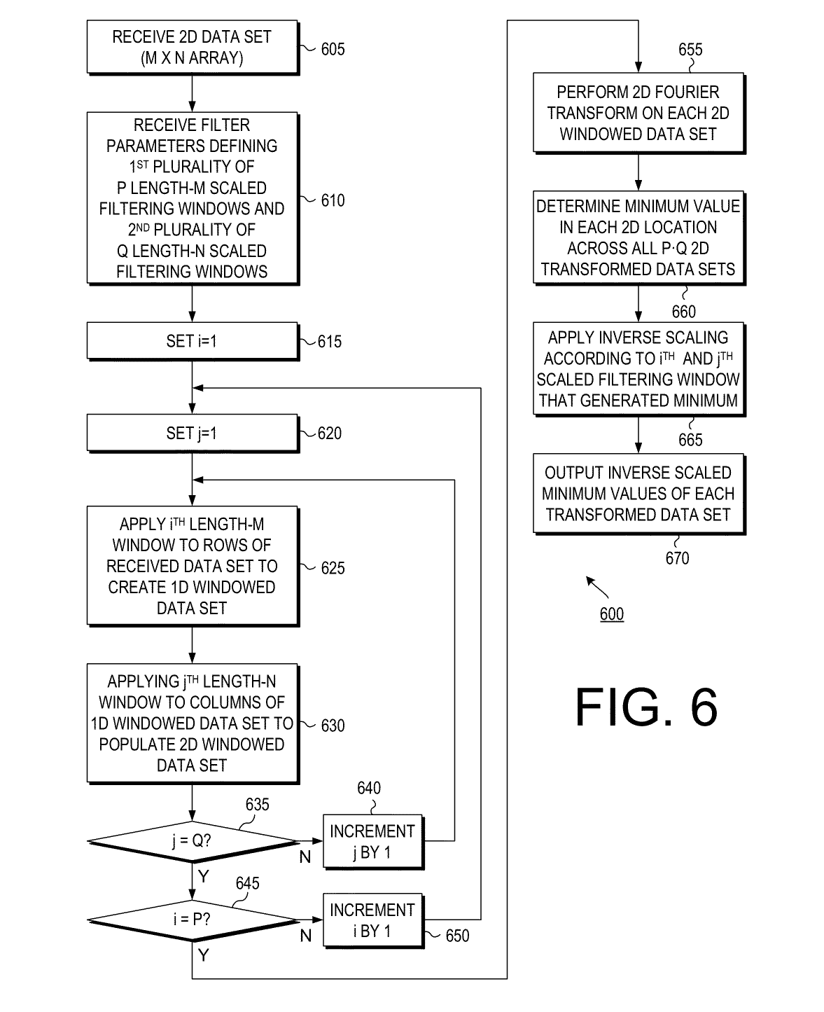

FIG. 6 is a flow chart showing the disclosed method 600 for operation on two-dimensional data, according to disclosed embodiments. As shown in FIG. 6, the method 600 begins by receiving a two-dimensional data set as an M×N array (605).

The method then receives filter parameters defining a first plurality of P length-M scaled filtering windows, and a second plurality of Q length-N scaled filtering windows (610).

The method then sets a value for i to be equal to 1 (615), and sets a value for j to be equal to one (620). In this case, i is an index value that ranges from 1 to P, and j is an index value that ranges from 1 to Q.

The method then applies an i^{th} length-M window to the rows of the received data set to create a one-dimensional windowed data set (625), and applies a j^{th} length-N window to the rows of the received data set to populate a two-dimensional windowed data set (i.e., an M×N windowed data array) (630).

The method then determines whether j is equal to Q (635). If j is not equal to Q, then the method increments j by 1 (640), and returns to operation 625. This allows the method to process the next element in the second plurality of Q length-N scaled filtering windows.

If j is equal to Q, the method then determines whether i is equal to P (645). If i is not equal to P, then the method increments i by 1 (650), and returns to operation 620. This allows the method to process the next element in the first plurality of P length-M scaled filtering windows.

If i is equal to P, the method then performs a Fourier transform on each two-dimensional windowed data set (e.g., M×N windowed data array) (655). In doing this, the method creates P·Q two-dimensional transformed data sets (e.g., P·Q M′×N′ transformed data arrays).

The method then determines a minimum value in each two-dimensional location across all of the P·Q two-dimensional transformed data sets (660), generating a two-dimensional intermediate data set (e.g., an M′×N′ intermediate data array).

The method then applies inverse scaling according to the i^{th} and j^{th} scaled filtering window that generated the selected minimum value (665). In performing this operation, the method can generate a two-dimensional output data set (e.g., an M′×N′ inverse-scaled data array).

Finally, the two-dimensional output data set is outputted as output data (670).

### COMPARATIVE EXAMPLES

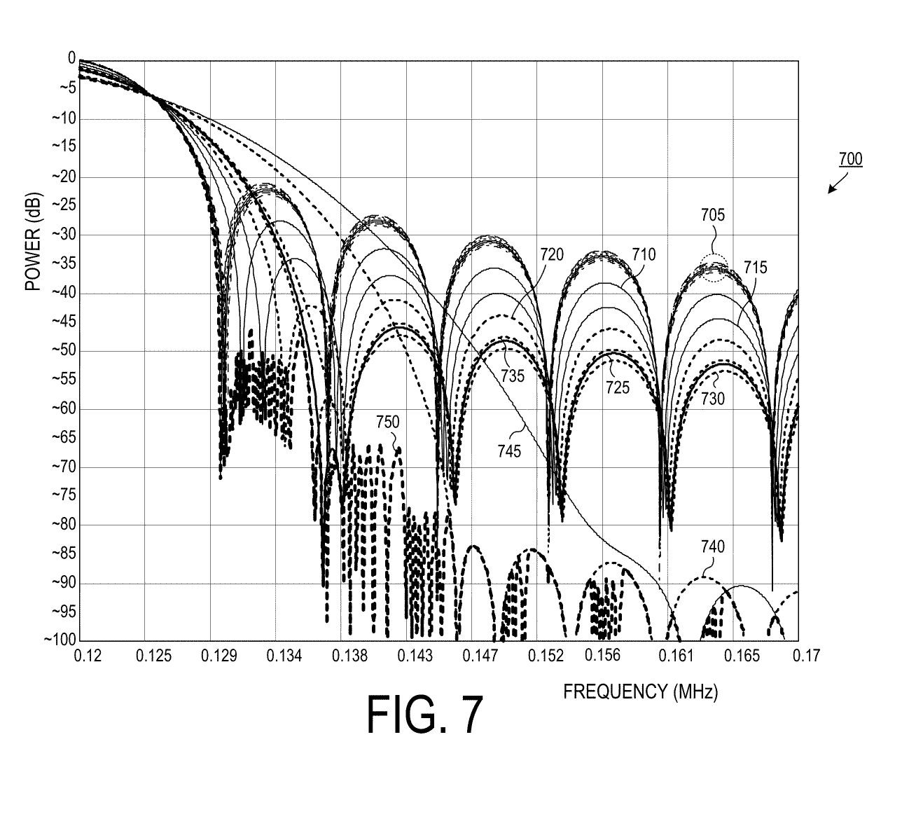

FIG.7 is a graph showing a low-pass filter function based on the disclosed methods, in which both the final output, and the intermediate functions provided by the different tapered windows are shown, according to a disclosed embodiment.

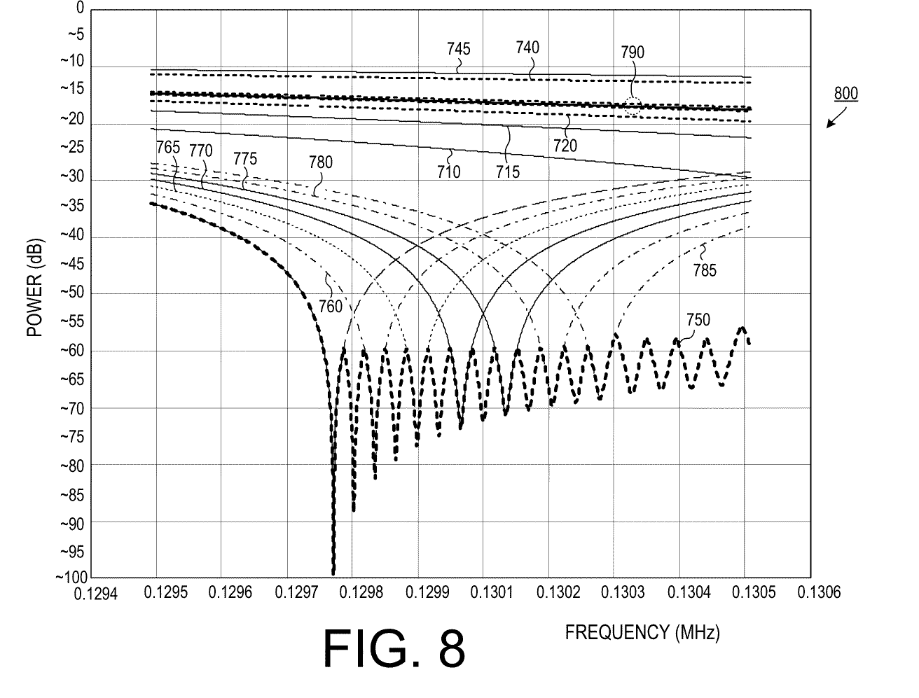

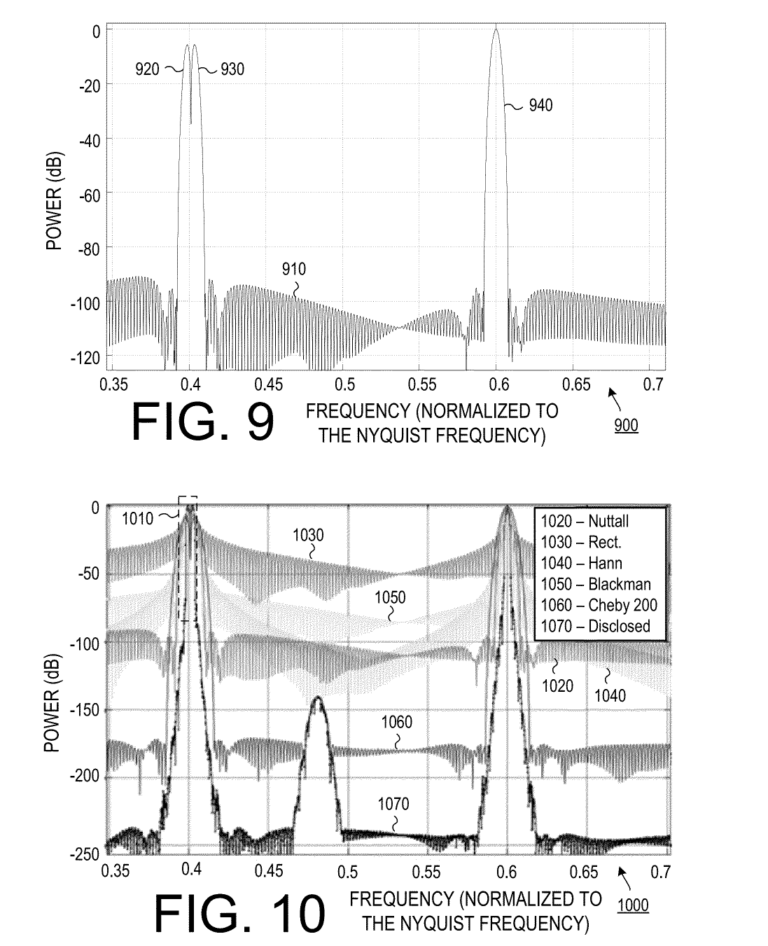

FIG. 8 is an expanded view of FIG. 7, showing in greater detail how multiple different window taper functions create a notch at a different frequency, according to disclosed embodiments.

As shown in FIGS. 7 and 8, fifteen exemplary window taper functions are examined: a rectangular window taper function 755, six sine taper functions 760, 765, 770, 775, 780, 785, a Hamming window taper function 710, a Blackman window taper function 715, a Nuttall window taper function 720, four Kaiser window taper functions 725, 730, 735, 745, and a Kaiser-squared window taper function 740. These individual window functions are compared against the results of the disclosed windowing operation 750, as described above with respect to FIGS. 1-5.

As shown in FIGS. 7 and 8, the final output 750 produced by the disclosed methods always chooses the lowest sidelobe of any of the window tapers.

FIG. 9 is a graph showing the suppression of signal strength in classic windowing methods. In FIG. 9, the results from a simulation containing four sine waves is shown, resulting in four tones in the received signal. First and second tones 920, 930 are close together at about −8 dB of amplitude and at a frequency of 0.4002 and 0.4025 Hz (normalized to Nyquist). The third tone is buried at −140 dB of amplitude and a frequency of 0.481 Hz, and can only be detected by the 200 dB Chebychev filter (1060) shown in FIG. 10 below. As a result, the third tone is not shown in the graph of FIG. 9. The fourth tone 940 is at 0 dB of amplitude and a frequency of 0.6 Hz.

As shown in the graph of FIG. 9, only one of the tones in the windowed signal approaches 0 dB. Two others are 8 dB down, and the final one is buried at −140 dB. As a result, the window taper function used in FIG. 9 is only ideal for identifying one of the four tones, is sub-optimal for detecting two other tones, and is unable to identify the final tone.

FIG. 10 is a graph comparing several alternate window taper functions to the output of the circuit of FIG. 1 using the method of FIG. 5. The graph of FIG. 10 shows an analysis of the same data as used in FIG. 9 but with additional windows, as well as the output of the disclosed system and method. The plot of FIG. 10 shows how the −140 dB tone that was invisible in FIG. 9 is pulled 100 dB above the floor by the disclosed system and method.

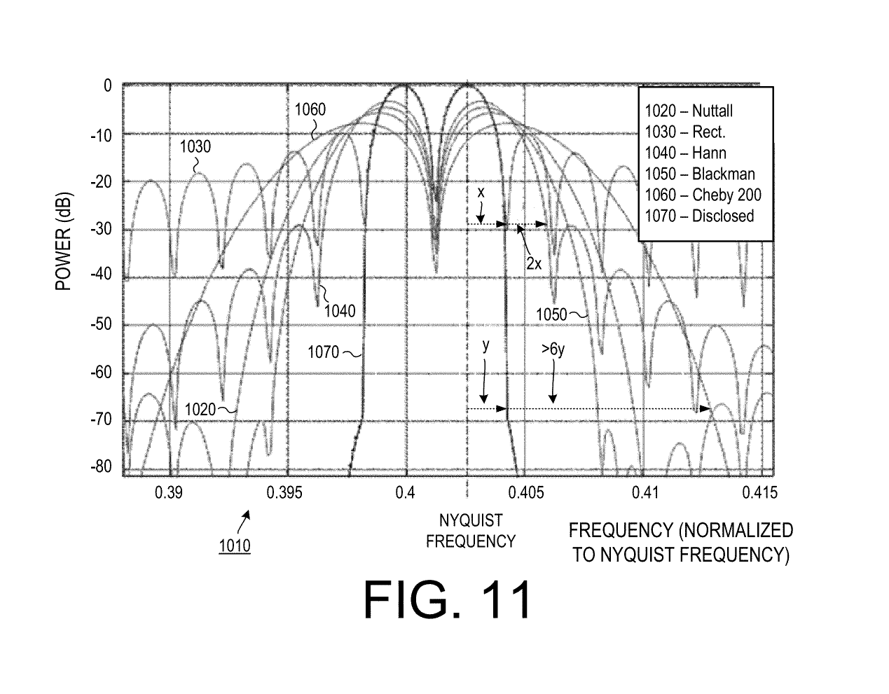

FIG. 11 is an expanded view of a portion 10 of FIG. 10 showing the significantly higher resolution, and the lack of suppression on close tones achieved according to a disclosed embodiment.

As shown in FIGS. 10 and 11, five exemplary window taper functions are examined: a Nuttall window taper function 1020, a rectangular window taper function 1030, a Hanning window taper function 1040, a Blackman window taper function 1050, and a Chebychev window taper function 1060. These individual window functions are compared against the results of the disclosed windowing operation 1070, as described above with respect to FIGS. 1-5.

A comparison of FIG. 11 to FIG. 9 shows how the method of applying a window taper in FIG. 9 suppresses close tones, while the method used in the example of FIG. 11 does not.

Conclusion

This disclosure is intended to explain how to fashion and use various embodiments in accordance with the invention rather than to limit the true, intended, and fair scope and spirit thereof The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

What is claimed is:

1. A method of processing data, comprising:
receiving an initial data record, the initial data record including N initial data points;
receiving parameters defining P scaled window taper functions that have P scaling factors α₁ to α_{P}, respectively, each of the P scaled window taper functions having N window taper values, and the N values in each window taper function summing to A/αₖ;
multiplying the N window taper values in each of the P window taper functions, respectively, by the N initial data points in the initial data record to generate P windowed data records, each of the P windowed data records including N windowed data points;
performing a Fourier transform on each of the P windowed data records to generate P transformed data records, respectively, each of the P transformed data records including N′ transformed data points;
choosing N′ minimum data points, the N′ minimum data points each being a minimum value of P transformed data points in corresponding positions in each of the P transformed data records, the N′ minimum data points corresponding to N′ selected window taper functions, respectively, which have N′ selected scaling factors, respectively, the N′ selected scaling factors each being one of the P scaling factors α₁ to α_{P}; and
multiplying each of the N′ minimum data points by a corresponding one of the N′ selected scaling factors, respectively, to generate an output data record including N′ output data points;
wherein
during the operation of choosing the N′ minimum data points, if an identical minimum value occurs multiple times in the P transformed data points, a selected minimum value and a corresponding selected window taper function is deemed to be a window taper function with the smallest scale factor, among a plurality of window taper functions associated with the identical minimum;
each of the N′ selected window taper functions correspond to a scaling factor associated with the selected window taper function,
each of the N′ selected scaling factors being one of the P scaling factors that is associated with a corresponding one of the N′ selected window taper functions, and
wherein
A is a real number,
k is an index value that varies from 1 to P,
N is an integer greater than 1,
N′ is an integer greater than 1, and
P is an integer greater than 1.

2. The method of claim 1, wherein
each of the P scaling factors, α₁ to α_{P}, is adjusted such that a peak of the transformed data records is the same for all of the P scaled window taper functions when the initial data record contains a first and a second sinusoid, the first sinusoid being x cycles, and the second sinusoid being (x+1) cycles, and
x is an integer greater than or equal to 1.

3. The method of claim 1, further comprising
performing an inverse Fourier transform on the output data record to generate a feedback data record, the feedback data record including N feedback data points;
repeating the operations of receiving an initial data record, receiving parameters defining P scaled window taper functions, multiplying each of the N initial data points in the initial data record by the P window taper functions, performing a Fourier transform on each of the P windowed data records, choosing N minimum data points, and multiplying each of the N minimum data points by a corresponding one of N selected scaling factors using the feedback data record as the initial data record for a second iteration.

4. The method of claim 1, wherein the initial data record is one of: radar reflection data, sonar reflection data, echo-cardiogram reflection data, audio data, video data, radio signal data, X-ray image data, ultrasound reflection data, a magnetic resonance imaging data, seismic data, astronomical data, seismic data, or stock price data.

5. The method of claim 1, wherein the P scaled window taper functions include at least one of: a rectangular window taper function, a triangular taper function, a first order sine taper function, a first order cosine taper function like a Hanning window taper function and a Hamming window taper function, a second order cosine taper function like a Blackman window taper function, a third order cosine taper function like a Nuttall window taper function, a Gaussian window taper function, a Tukey window taper function, a Parzen window taper function, a Bohman window taper function, a Chebychev window taper function, a Taylor window taper function, a Kaiser window taper function, and a window taper function that is the square of one of the aforementioned window taper functions.

6. The method of claim 1, further comprising
receiving a preliminary data record, the preliminary data record including B preliminary data points;
scaling the preliminary data record to generate the initial data record,
wherein B is an integer greater than 1.

7. A method of processing data, comprising:
receiving an N×1 data record vector including N initial data points;
receiving parameters defining a N×P scaled window taper function array including P columns, each with a N rows, such that each column contains a different length-N scaled window taper function, where the scaled window taper function array has P scaling factors α₁ to α_{P}, respectively, each of the P scaling factors being associated with one of the scaled window taper functions, and where the N points in each window taper function sum to A/αₖ, where A is a real number
multiplying each of the data points in a column of the scaled window taper function array by the corresponding data point in the data record vectorto generate an N×P windowed data array including N·P windowed data points;
performing a Fourier transform on each column of the windowed data array to generate an N′×P transformed data array including N′·P transformed data points, wherein i is an index ranging from 1 to N;
choosing, for each of the N′ rows in the transformed data array, the minimum value across all of the columns in the transformed data array, wherein a, is the minimum value and aᵢ occurs in a g^{th} column of the transformed data array, wherein if an identical minimum value occurs in multiple columns within one row, g is deemed to be the column, among the columns with the identical minimum value, associated with the window taper function having the smallest scale factor, and where b(i)=g;
generating an N′×1 intermediate output vector, the intermediate output vector including N′ intermediate elements a₁ to a_{N′};
generating an N′×1 scaling factor vector, the scaling factor vector including N′ scaling elements c₁ to c_{N′}, where cᵢ=═_{b(i)}; and
multiplying each of the N′ intermediate elements in the intermediate output vector by a corresponding one of the N′ scaling elements in the scaling factor vector to generate an N′×1 data output vector, the data output vector including N′ output data elements d₁ to d_{N′}, where dᵢ=aᵢ*cᵢ.
wherein
i is a first index ranging from 1 to N′, and
k is a second index ranging from 1 to P

8. The method of claim 7, wherein
each of the N′ scaling factors a₁ to a_{N′} is adjusted such that P peaks of the P columns, respectively, of transformed data array are identical when the record vector contains a first and second sinusoid, the first sinusoid being x cycles, and the second sinusoid being (x+1) cycles, and
x is an integer greater than or equal to 1.

9. The method of claim 7, wherein the initial data record is one of: radar reflection data, sonar reflection data, echo-cardiogram reflection data, audio data, video data, radio signal data, X-ray image data, ultrasound reflection data, a magnetic resonance imaging data, seismic detector, astronomical data, or seismic data.

10. A signal processing device, comprising:
a signal gathering element configured to gather target data about a physical characteristic of a target; and
a data processor configured to
receive a digital data record, the digital data record including N received data elements selected from the target data;
receive parameters defining P scaled window taper functions that have P scaling factors α₁ to α_{P}, respectively, each of the P scaled window taper functions having N window taper values, and the N values in each window taper function summing to A/αₖ;
multiply the N window taper values in each of the P window taper functions, respectively, by the N received data elements in the digital data record to generate P windowed data records, each of the P windowed data records including N windowed data elements;
perform a Fourier transform on each of the P windowed data records to generate P transformed data records, respectively, each of the P transformed data records including N′ transformed data elements;
choose N′ minimum data elements, the N′ minimum data points each being a minimum value of P transformed data elements in corresponding positions in each of the P transformed data records, the N′ minimum data elements corresponding to N′ selected window taper functions, respectively, which have N′ selected scaling factors, respectively, the N′ selected scaling factors each being one of the P scaling factors α₁ to α_{P};
generate a refined data record based on the N′ minimum data elements, the refined data record having N′ refined data elements; and
providing the refined data record as an output data record.

11. The device of claim 10, wherein the P scaled window taper functions include at least one of: a rectangular window taper function, a triangular taper function, a first order sine taper function, a first order cosine taper function like a Hanning window taper function and a Hamming window taper function, a second order cosine taper function like a Blackman window taper function, a third order cosine taper function like a Nuttall window taper function, a Gaussian window taper function, a Tukey window taper function, a Parzen window taper function, a Bohman window taper function, a Chebychev window taper function, a Taylor window taper function, a Kaiser window taper function, and a window taper function that is the square of one of the aforementioned window taper functions.

12. The device of claim 10, wherein the signal gathering element is one of: a radar, a radar array, a sonar, a sonar array, an echo-cardiogram, an echo-cardiogram array, a microphone, a microphone array, a digital camera, a digital camera array, a hydrophone, a hydrophone array, an antenna, an antenna array, an X-ray detector, an X-ray detector array, an ultrasound detector, an ultrasound detector array, a magnetic resonance imaging device, a magnetic resonance imaging device array, a radio telescope, a radio telescope array, a seismic detector, or a seismic detector array.

13. The device of claim 10, further comprising:
a display element configured to display the output data record.

14. The device of claim 10, wherein the signal gathering element is an active detecting element that both emits transmit signals and detects reflected signals.

15. The device of claim 10, wherein the signal gathering element is a passive detecting element that detects receive signals.

16. An method of processing data, comprising:
receiving N length-M data records in an M×N data record array D, with M rows and N columns, including N·M initial data points;
receiving first parameters defining a P×N scaled window taper function array E, including P rows, each with a N columns, such that each row contains a length-N scaled window taper function, where the scaled window taper function array has P scaling factors α₁ to α_{P}, respectively, and where the N points in each window taper function sum to A/αᵢ, where A is a real number, and i is an index from 1 to P;
receiving second parameters defining a M×Q scaled window taper function F, array including Q columns, each with a M rows, such that each column contains a length-M scaled window taper function, where the scaled window taper function array has Q scaling factors β₁ to β_{Q}, respectively, and where the M points in each window taper function sum to A/βⱼ, where A is a real number, and j is an index from 1 to Q;
generating M row by N column arrays K_{1,1}(1 . . . M: 1 . . . N) to K_{P,Q}(1 . . . M: 1 . . . N), for the H=P*Q combinations of i ∈ {1 . . . P} and j ∈ {1 . . . Q}, by multiplying the rows of D by the i^{th} row of E to generate G, and then the multiplying the columns of G by the j^{th} column of F to create array K_{i,j}(1 . . . M: 1 . . . N);
generating arrays L_{1,1}(1 . . . M′: 1 . . . N′) to L_{P,Q}(1 . . . M′: 1 . . . N′), each with M′ rows and N′ columns, by performing a 2D Fourier transform on the arrays K_{1,1} to K_{P,Q};
finding the i, j index pairs, where i ∈ {1 . . . P} and j ∈ {1 . . . Q}, that produce a minimum value for L_{i,j}(y, x) for each y, x, location, where y ∈ {1 . . . M′} and x ∈ {1 . . . N′};
setting array R(y,x) equal to L_{i,j}(y, x) at an i , j index pair that produces a minimum value at any given y,x location;
setting S(,y,x)=αᵢ*βⱼ at an i, j index pair that produces a minimum value for αᵢ*βⱼ for the one or more i, j index pairs that produce a minimum value;
setting U(,y, x)=R(y, x)*S(y, x) for each y, x, location, where y ∈ {1 . . . M′} and x ∈ {1 . . . N′};
outputting the array U as the processed data.
